(19) United States
(12) Patent Application Publication
(10) Pub. No.: US 2011/0154249 A1
(43) Pub. Date: Jun. 23, 2011

(54) MOBILE DEVICE AND RELATED CONTROL METHOD FOR EXTERNAL OUTPUT DEPENDING ON USER INTERACTION BASED ON IMAGE SENSING MODULE

(75) Inventors: Si Hak JANG, Yongin-si (KR); Hee Woon KIM, Suwon-si (KR)

(73) Assignee: SAMSUNG ELECTRONICS CO. LTD., Suwon-si (KR)

(21) Appl. No.: 12/974,320

(22) Filed: Dec. 21, 2010

(30) Foreign Application Priority Data
Dec. 21, 2009 (KR) 10-2009-0127896

(51) Int. Cl. G06F 3/048

(52) U.S. Cl. 715/781; 715/863

(57) ABSTRACT

A mobile device for supporting an external output function has a projector module and at least one image sensing module. The mobile device activates the image sensing module when entering into an external output mode, and outputs screen data externally in the external output mode. The mobile device detects a user interaction based on the image sensing module in the external output mode, and controls the external output of the screen data, according to the user interaction. An image of the screen data outputted externally may be acquired using the image sensing module and, based on the acquired image, new content may be created.

### PRIORITY

This application claims the benefit under 35 U.S.C. §119(a) of a Korean patent application filed on Dec. 21, 2009 in the Korean Intellectual Property Office and assigned Serial No. 10-2009-0127896, the entire disclosure of which is hereby incorporated by reference.

### BACKGROUND OF THE INVENTION

1. Field of the Invention

The present invention relates in general to a mobile device. More particularly, the present invention relates to a mobile device and a related control method for an external output according to a user interaction based on an image sensor module in an external output mode.

2. Description of the Related Art

With modern scientific advances, a great variety of mobile devices have been developed, including cellular phones, smart phones, Personal Digital Assistants (PDAs), many types of digital multimedia players, etc. Normally such a mobile device outputs screen data to be displayed on a screen through a built-in display unit. However, due to inherent limitations in size of the mobile device, the display unit of the mobile device may also have a relatively smaller size.

For the above reasons, a user may often experience difficulty in sharing data displayed on the size-limited display unit with other users. To solve this problem, one recent approach is to enable the mobile device to output its displayed data on an external display apparatus with a relatively larger screen. However, this may also cause inconvenience to a user because a suitable external display apparatus is required that can be connected to the mobile device.

Another approach is to provide the mobile device with an image projection function. For example, a projector module may be employed for the mobile device. This built-in projector module of the mobile device magnifies screen data, i.e., images displayed on the internal display unit, and then projects the images onto an external screen. A user can therefore see the projected data on a sufficiently larger-sized external screen instead of a smaller-sized internal display unit of the mobile device.

The mobile device having the projector module is typically controlled using a separate remote controller or by applying a physical force to a built-in control member (e.g., a button, a touch screen, etc.) in the mobile device. The latter conventional control method based on a physical contact may often cause the mobile device to shake due to a force applied by a user. This unintended shake of the mobile device may then give rise to a shake or variations in position of screen data that is outputted on the external screen from the mobile device. In order to correct or prevent such a shake of screen data, a user should take necessary, but annoying, actions. Additionally, the former conventional control method using a remote controller may be inconvenient because of having to carry the remote controller as well as the mobile device.

### SUMMARY OF THE INVENTION

An aspect of the present invention is to address at least the above-mentioned problems and/or disadvantages and to provide at least the advantages described below. Accordingly, an aspect of the present invention is to provide the above-mentioned problems and/or disadvantages and to offer at least the advantages described below.

In accordance with an aspect of the present invention a mobile device having an external output function that supports an output of screen date to an external screen and an input for a control of the screen data being outputted is provided.

Another aspect of the present invention is to provide a mobile device and method for simply and effectively controlling an external output of content from the mobile device without any physical contact on the mobile device.

Another aspect of the present invention is to provide a mobile device and method for controlling an external output according to a user interaction based on an image sensor module of the mobile device.

Another aspect of the present invention is to provide a mobile device and method for allowing a creation of new content from a combination of an external output and an object based on a user interaction in an external output mode.

According to an aspect of the present invention, a method for controlling an external output of a mobile device is provided. The method includes activating an image sensing module when entering into an external output mode, outputting screen data externally in the external output mode; detecting a user interaction based on the image sensing module in the external output mode; and controlling the external output of the screen data according to the user interaction.

According to another aspect of the present invention, a mobile device is provided. The mobile device includes a projector module for outputting screen data to an external screen; a memory unit for storing setting information related to a control of an external output function; at least one image sensing module for detecting a user interaction in an external output mode based on the projector module; and a control unit for receiving the user interaction from the image sensing module and for controlling an external output of the screen data according to the received user interaction.

According to another aspect of the present invention, a method of controlling an external output of a mobile device is provided. The method includes projecting an image from the mobile device to an external object while operating in an external output mode, detecting a user interaction while operating in the external output mode, and controlling the projection of the image according to the detected user interaction, wherein the user interaction is one of a first user interaction occurring between the mobile device and the external object and a second user interaction occurring around the mobile device but not necessarily between the mobile device and the external object.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1 and 2 are schematic views illustrating mobile devices in accordance with exemplary embodiments of the present invention;

FIG. 3 is a block diagram illustrating the configuration of a mobile device in accordance with an exemplary embodiment of the present invention;

FIG. 4 is a view illustrating a control method according to a user interaction occurring between a mobile device and an external screen in accordance with an exemplary embodiment of the present invention;

FIGS. 5 to 10 are views illustrating examples of controlling an external output according to a user interaction detected by a first image sensing module of a mobile device in accordance with exemplary embodiments of the present invention;

FIG. 11 is a view illustrating a control method according to a user interaction occurring around a mobile device in accordance with an exemplary embodiment of the present invention;

FIGS. 12 and 13 are views illustrating examples of controlling an external output according to a user interaction detected by a second image sensing module of a mobile device in accordance with exemplary embodiments of the present invention;

FIG. 14 is a flow diagram illustrating a method for controlling an external output according to a user interaction based on an image sensing module of a mobile device in accordance with an exemplary embodiment of the present invention; and

FIG. 15 is a flow diagram illustrating a method for controlling an external output according to a user interaction based on different image sensing modules of a mobile device in accordance with an exemplary embodiment of the present invention.

Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

This invention proposed herein relates to a mobile device supporting an external output function and also a method for controlling an external output of the mobile device. In particular, exemplary embodiments of the present invention provide a mobile device and method for receiving a user interaction based on at least one image sensing module during an external output performed in an external output mode and then controlling an external output function according to the received user interaction. Additionally, exemplary embodiments of the present invention further provide a mobile device and method for creating new content from a combination of screen data outputted externally in an external output mode and an object occurring based on a user interaction. Other exemplary embodiments of the present invention to be described hereinafter employ a projector module as a representative of a device for performing an external output function.

A mobile device according to exemplary embodiments of the present invention may include a projector module, at least one image sensing module that detects a user interaction when the projector module outputs externally screen data, and a control unit that analyzes the user interaction received from the image sensing module and then performs a necessary control process based on analysis. When the projector module outputs screen data of specific content externally, the mobile device may control an external output according to the user interaction detected by the image sensing module.

A mobile device having the projector module and the image sensing module is described below. The embodiments described below are, however, exemplary only and not to be considered as a limitation of the present invention. Other embodiments could be used without departing from the scope of the present invention.

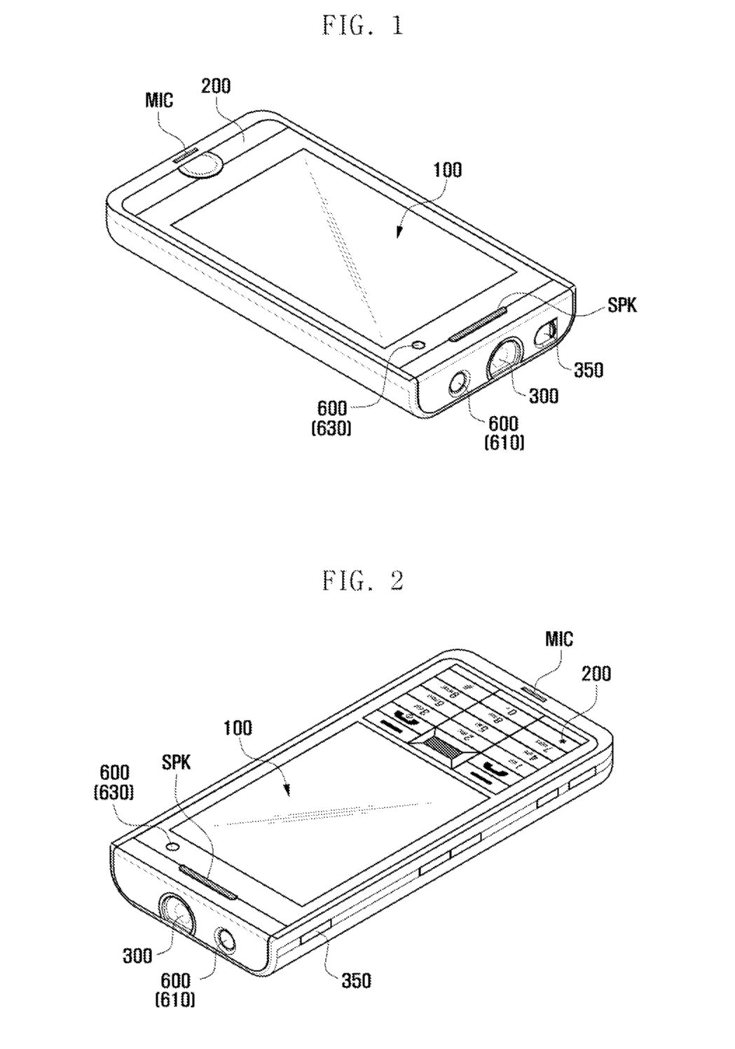

FIGS. 1 and 2 are schematic views illustrating mobile devices in accordance with exemplary embodiments of the present invention. FIG. 1 shows a bar-type mobile device having a full touch screen, and FIG. 2 shows another bar-type mobile device having separately a display unit and an input unit.

Referring to FIGS. 1 and 2, the mobile device has a display unit 100 that outputs various screen data according to the execution of functions of the mobile device, an input unit 200 that creates various input signals, a projector module 300 that magnifies screen data and projects the screen data onto an external screen, a focus controller 350 that regulates a focus of the projector module 300, a speaker (SPK) that outputs various audio signals, a microphone (MIC) that receives external audio signals such as user's voice, and at least one image sensing module 600 that detects a user interaction. The mobile device may include additional and/or different units. Similarly, the functionality of two or more of the above units may be integrated into a single component.

The image sensing module 600 may include the first image sensing module 610 and the second image sensing module 630. When the mobile device performs an external output function by enabling the projector module 300 to project screen data onto the external screen, the first image sensing module 610 detects one type of user interaction that occurs between the mobile device and the external screen. The second image sensing module 630 detects other type of user interaction that occurs around the mobile device. These image sensing modules 610 and 630 may receive a user interaction during an external output based on the projector module 300, create resultant interaction information, and send the interaction information to the control unit of the mobile device.

The first image sensing module 610 is located on the same side of the mobile device as the projector module 300 is equipped. The first image sensing module 610 can detect a user interaction that occurs between the mobile device and the external screen, and can also take a photograph to acquire an image of screen data projected onto the external screen and an image of an object produced on the external screen by user interaction. The second image sensing module 630 is located on any side of the mobile device allowing for detection of a user interaction that occurs around the mobile device. For example, as shown in FIGS. 1 and 2, the second image sensing module 630 may be formed on a part of the front side of the mobile device. Such locations of the image sensing modules 610 and 630 shown in FIGS. 1 and 2 are exemplary only and thus may be varied according to types of the mobile device.

Although the mobile devices illustrated in FIGS. 1 and 2 include the first and second image sensing modules 610 and 630, a mobile device according to an exemplary embodiment of the present invention is not limited to that arrangement. The mobile device may have only one image sensing module, or may have three or more image sensing modules. Similarly, the first and second image sensing modules 610 and 630 may be formed of a camera module. For example, the second image sensing module 630 may be formed of a proximity sensing module as well known in the art.

According to an exemplary embodiment of the present invention, the projector module 300 outputs externally various screen data produced in the mobile device. The projector module 300 is located on one side of the mobile device. The location of the projector module 300 may be set so that a projection direction of the projector module 300 is equal to a sensing direction of the first image sensing module 610.

According to an exemplary embodiment of the present invention, a user interaction detected by the first image sensing module 610 includes various types of user gestures that are made between the external screen and the mobile device, the formation of distinguishably shaped or colored points via a pointing tool, a laser pointer, etc. on screen data projected onto the external screen, and the formation of particular signs via a marker, etc. on screen data projected onto the external screen. A user interaction detected by the second image sensing module 630 includes some predefined user gestures, such as a sweep, that are made around the mobile device.

In addition to bar-type mobile devices exemplarily shown in FIGS. 1 and 2, other types of mobile device may be employed, such as a folder type, a slide type, and a flip type. The mobile device may include communication devices, multimedia players and their application equipment, each of which is capable of controlling an external output function through the projector module 300 and the image sensing module 600. For example, the mobile device may include many types of mobile communication terminals based on various communication protocols, a Portable Multimedia Player (PMP), a digital broadcasting player, a Personal Digital Assistant (PDA), a music player (e.g., an MP3 player), a portable game console, a smart phone, a tablet PC, and the like. The mobile device may also include a TV, a Large Format Display (LFD), a Digital Signage (DS), a media pole, a personal computer, a notebook, etc.

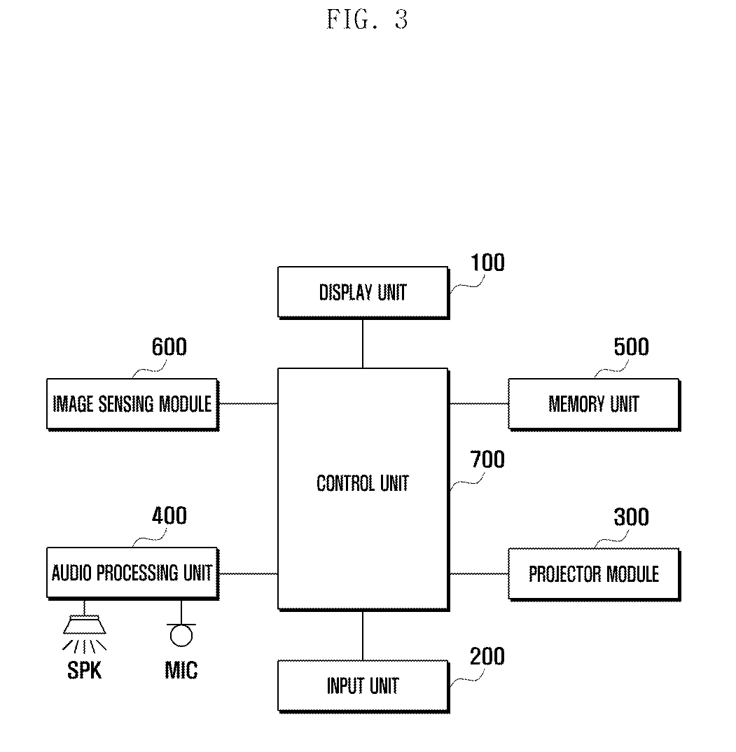

The configuration of the mobile device exemplarily shown in FIGS. 2 and 3 is described below with reference to FIG. 3. Although FIG. 3 shows only one image sensing module 600, this may be interpreted as the first and second image sensing modules 610 and 630 as discussed above. In exemplary embodiments, the second image sensing module 630 may be omitted or replaced with a proximity sensing module.

FIG. 3 is a block diagram illustrating the configuration of a mobile device in accordance with an exemplary embodiment of the present invention.

Referring to FIG. 3, the mobile device includes an input unit 200, an audio processing unit 400, a display unit 100, a memory unit 500, a projector module 300, an image sensing module 600, and a control unit 700. The audio processing unit 400 may have a speaker (SPK) and a microphone (MIC). Each of the above elements is described below. The mobile device may include additional and/or different units. Similarly, two or more of the above units may be integrated into a single component.

The input unit 200 creates an input signal for entering letters and numerals and an input signal for setting or controlling functions of the mobile device, and then delivers them to the control unit 700. The input unit 200 includes a plurality of input keys and function keys to create such input signals. The function keys may have navigation keys, side keys, shortcut keys (e.g., a key for performing a projector function, a key for activating the image sensing module), and any other special keys defined to perform particular functions. The input unit 200 may further have a focus controller 350 for regulating a focus of the projector module 300 as shown in FIGS. 1 and 2.

The input unit 200 may be formed of one or combination of a touchpad, a touch screen, a keypad having a normal key layout (e.g., 3*4 or 4*3 key layout), a keypad having a QWERTY key layout, a dome key arrangement, and the like. The input unit 200 may create input signals for performing a projector function and for activating the image sensing module 600 and then offer them to the control unit 700. These input signals may be created in the form of a key press signal on a keypad or a touch signal on a touchpad or touch screen.

The audio processing unit 400 may include a speaker (SPK) for outputting audio signals of the mobile device and a microphone (MIC) for collecting audio signals such as a user's voice. The audio processing unit 400 converts an audio signal received from the microphone (MIC) into data, and outputs the audio signal to the control unit 700. The audio processing unit 400 also outputs an audio signal inputted from the control unit 700 through the speaker (SPK). The audio processing unit 400 may output various audio components produced in the mobile device according to the user's selection. Audio components may include audio signals produced by a playback of audio or video data, and sound effects related to the execution of a projector function.

The display unit 100 represents a variety of information inputted by a user or offered to a user, including various screens activated by the execution of functions of the mobile device. For example, the display unit 100 may visually output a boot screen, an idle screen, a menu screen, a list screen, a content play screen, an application execution screen, and the like. The display unit 100 may offer various screen data related to states and operations of the mobile device. The display unit 100 may be formed of a Liquid Crystal Display (LCD), a Plasma Display Panel (PDP), a Light Emitting Diode LED), a Organic LED (OLED), a Active Matrix OLED (AMOLED), or any other equivalent. In addition, the display unit 100 may be formed of a touch screen that acts together as input and output units. In this case, the aforesaid input unit 200 may be omitted from the mobile device.

When the mobile device is operating in an external output mode, the display unit 100 may display screen data outputted from the control unit 700 during the execution of a projector function and also may display virtual items based on a specific Graphical User Interface (GUI) to control an external output according to a projector function. When the mobile device performs a projector function, the display unit 100 may display screen data being projected onto the external screen under the control of the control unit 700. Additionally, under the control of the control unit 700, the display unit 100 may further display GUI-based virtual items, used for a control related to an external output, on the above screen data.

The memory unit 500 stores content created and used in the mobile device. Such content may be received from external entities such as other mobile devices and personal computers. Content may be used with related data including video data, audio data, broadcast data, photo data, message data, document data, image data, game data, etc. Additionally, the memory unit 500 may store various applications for particular functions supported by the mobile device. For example, the memory unit 500 may store a specific application necessary for the execution of a projector function of the mobile device. The memory unit 500 may also store virtual items predefined for a control of a projector function and may store setting information and software related to a control of screen data being projected externally through the projector module 300.

The memory unit 500 may further store option information related to an external output function of the mobile device. The option information may contain activation setting information that defines the activation of the image sensing module 600 in an external output mode, and function setting information that defines available functions for each user interaction inputted for an external output control of currently executed content. The activation setting information may indicate whether the image sensing module 600 is automatically activated or selectively activated by a user when the mobile device enters into an external output mode. As will be described below, the function setting information may be classified into first function setting information related to the first image sensing module 610 and second setting information related to the second image sensing module 630. Such setting information may be offered as default values and also may be modified, deleted, and added.

The memory unit 500 may further store display information that defines a relation between internal screen data and external screen data. The internal screen data denotes screen data displayed on the display unit 100, and the external screen data denotes screen data projected onto the external screen. Display information indicates whether to display the internal screen data on the display unit 100 in an external output mode. The display information indicates which information is to be offered together with at least one of the internal screen data and the external screen data. This information may be offered on screen data as a pop-up window. The memory unit 500 may further store setting information that defines a processing policy of screen data according to a user interaction in an external output mode. When the external screen data is updated according to a user interaction in an external output mode, this setting information may indicate whether to display the updated screen data as the internal screen data or to display information about manipulation, guide, etc. as will be discussed later.

The memory unit 500 may include at least one buffer that temporarily store data produced while functions of the mobile device are performed. For example, the memory unit 500 may perform a buffering for the external screen data projected on the external screen through the projector module 300. The memory unit 500 may also perform a buffering for data delivered from the image sensing module 600 in an external output mode.

The memory unit 500 may be internally embedded in the mobile device or externally attached, such as a smart card, to the mobile device. Many kinds of internal/external storages may be used for the memory unit 500, such as Random Access Memory (RAM), Read Only Memory (ROM), a flash memory, a multi-chip package memory, and the like.

The projector module 300 is internally embedded in or externally attached to the mobile device. The projector module 300 magnifies various screen data offered from the control unit 700 and outputs the magnified data to the external screen. The projector module 300 is capable of projecting, without any distortion, various screen data processed in the control unit 700 onto the external screen.

The image sensing module 600 detects a user interaction for a control of an external output function when the mobile device is in an external output mode, and delivers resultant interaction information to the control unit 700. The image sensing module 600 may detect user gestures, specific shapes or colors, signs produced by a marker, and the like.

When the mobile device is in an external output mode, the image sensing module 600 may be in one of a fixed detection mode and a normal detection mode under the control of the control unit 700. In the fixed detection mode, the image sensing module 600 is always kept in the on-state in order to receive a user interaction at any time when the mobile device is in an external output mode. In the normal detection mode, the image sensing module 600 can shift between the on-state and the off-state according to a user's selection when the mobile device is in an external output mode.

As discussed above, the image sensing module 600 may include the first image sensing module 610 capable of detecting a user interaction that occurs between the mobile device and the external screen, and the second image sensing module 630 capable of detecting a user interaction that occurs around the mobile device. The first image sensing module 610 is located on the same side of the mobile device as the projector module 300. Accordingly, the first image sensing module 610 can detect a user interaction that occurs between the mobile device and the external screen, and can also take a photograph to acquire an image of screen data projected onto the external screen and an image of an object produced on the external screen by a user interaction. The second image sensing module 630 is located on any side of the mobile device such that the second image scanning module 630 is capable of detecting a user interaction that occurs around the mobile device. For example, as shown in FIGS. 1 and 2, the second image sensing module 630 may be formed on a part of the front side of the mobile device.

The control unit 700 controls the mobile device and also controls the flow of signals in respective elements of the mobile device. The control unit 700 controls the signal flow among the input unit 200, the audio processing unit 400, the display unit 100, the memory unit 500, the projector module 300, and the image sensing module 600.

The control unit 700 controls an external output from the projector module 300, interprets information about a user interaction received from the image sensing module 600 as an interaction input for a function control of the mobile device, and controls an external output function of the mobile device in response to the interaction input. The control unit 700 controls an external output function, according to interaction information offered from the image sensing module 600. When the mobile device enters into an external output mode, the control unit 700 controls the image sensing module 600 according to predefined option information. When the mobile device is in the external output mode, the control unit 700 analyzes interaction information received from the image sensing module 600 and then controls an update of the external screen data according to the analyzed interaction information. When a user interaction occurs, the control unit 700 controls the image sensing module 600 to acquire an image of the external screen data on the external screen according to the type of current content outputted externally, and then creates new content based on the acquired image.

When the mobile device performs a projector function, the control unit 700 controls the output of the internal screen data on the display unit 100 and the output of the external screen data through the projector module 300. The control unit 700 may disable the display unit 100 or disallow a display of the internal screen data. Alternatively, the control unit 700 may simultaneously output the same screen data or separately output different screen data for the internal screen data and the external screen data. In the latter case, the internal screen data may be all prearranged screen views based on a user interface offered by the mobile device, whereas the external screen data may be a magnified screen view of data played or executed according to a selected application.

In addition, the control unit 700 controls an external output according to the image sensing module 600. The control unit 700 may separately control an external output by distinguishing a user interaction based on the first image sensing module 610 from a user interaction based on the second image sensing module 630.

Examples of control functions of the control unit 700 will be described later with reference to the drawings. As discussed heretofore, the control unit 700 performs the whole control according to the image sensing module 600, in association with an external output function based on the projector module 300. The above-described control functions of the control unit 700 may be implemented as software having a proper algorithm.

The mobile device according to an exemplary embodiment of the present invention is not limited to the configuration shown in FIG. 3. For example, the control unit 700 of the mobile device may have a baseband module used for a mobile communication service, and in this case the mobile device may further have a wireless communication module.

In addition, although not illustrated in FIGS. 1 to 3, the mobile device according to an exemplary embodiment of the present invention may essentially or selectively include other elements, such as a proximity sensing module (e.g., a proximity sensor, a light sensor, etc.), a location-based service module such as a GPS module, a camera module, a Bluetooth module, a wired or wireless data transmission interface, an Internet access module, a digital broadcast receiving module, and the like. According to a digital convergence tendency today, such elements may be varied, modified and improved in various ways, and any other elements equivalent to the above elements may be additionally or alternatively equipped in the mobile device. As will be understood by those skilled in the art, some of the above-mentioned elements in the mobile device may be omitted or replaced with another.

A control method for an external output function based on the projector module 300 in the mobile device is described with reference to the drawings. However, the following embodiment is exemplary only and not to be considered as a limitation of the present invention. Alternatively, other embodiments could be used without departing from the scope of the present invention.

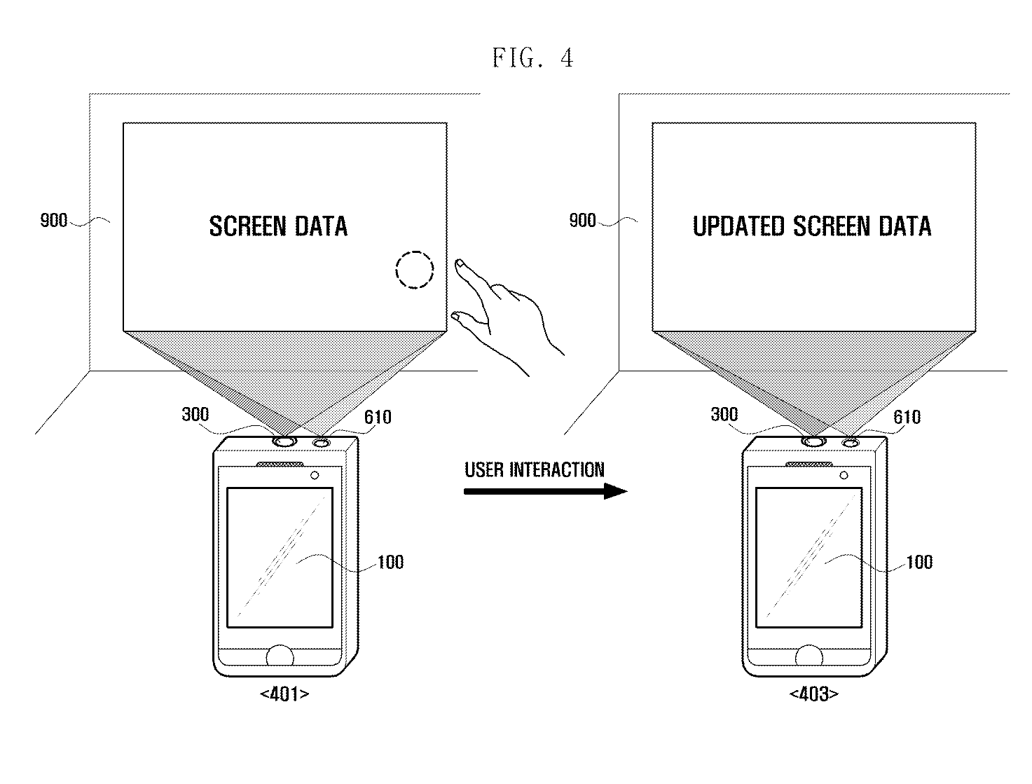

FIG. 4 is a view illustrating a control method according to a user interaction occurring between a mobile device and an external screen in accordance with an exemplary embodiment of the present invention.

Referring to FIG. 4, in an initial state 401, screen data of specific content is outputted through the projector module 300 of the mobile device and then projected onto the external screen 900. According to the user's manipulation, the mobile device executes a specific application and then outputs screen data related to the specific application to the external screen 900 through an external output function based on the projector module 300.

The external screen 900 is an object on which screen data outputted through the projector module 300 is displayed. A certain dedicated member (e.g., a white screen) or any other surface, such as a wall or a floor, may be used as the external screen 900. The external screen 900 is not a component of the mobile device and can be any object that allows screen data outputted through the projector module 300 to be projected thereon.

Screen data may include dynamic screen data of contents played or executed by various player applications (e.g., a video player application, a digital broadcast player application, a game application, etc.), and static screen data of contents displayed by various viewer applications (e.g., a text viewer application, an image viewer application, an e-book viewer application, etc.).

In the initial state 401, the user may produce an interaction for a control of screen data being outputted. For example, as shown in FIG. 4, the user may produce a certain user interaction between the mobile device and the external screen 900, i.e., within the recognizable range of the first image sensing module 610.

As discussed above, this user interaction may include various types of user gestures (e.g., intervention of the hand, movement of the hand, etc.), the formation of distinguishably shaped or colored points by means of a pointing tool, a laser pointer, etc. on screen data projected onto the external screen 900, the formation of particular signs, text, colors, etc. via a marker, etc. on screen data projected onto the external screen 900, and any other equivalent that can be recognized by the first image sensing module 610. Detailed examples will be described later.

The first image sensing module 610 detects a user interaction and delivers resultant interaction information to the control unit 700. The control unit 700 identifies the interaction information received from the first image sensing module 610. The control unit 700 further identifies a particular function corresponding to the interaction information and controls an external output according to the particular function. The control unit 700 controls selected content, according to a particular function based on interaction information, and also controls the output of screen data modified thereby. In the next state 403, updated screen data is offered to the external screen 900. Related examples will be described later with reference to the drawings.

When the mobile device is in the external output mode, the display unit 100 may be in the on-state (i.e., enabled) or in the off-state (i.e., disabled) according to a setting policy. If the display unit 100 is in the on-state, the internal screen data displayed on the display unit 100 may be identical to or different from the external screen data projected onto the external screen 900. For example, the external screen data may be screen data of content played by the execution of a specific application, and the internal screen data may be screen data offering manipulation information about content, content information, execution information, and the like.

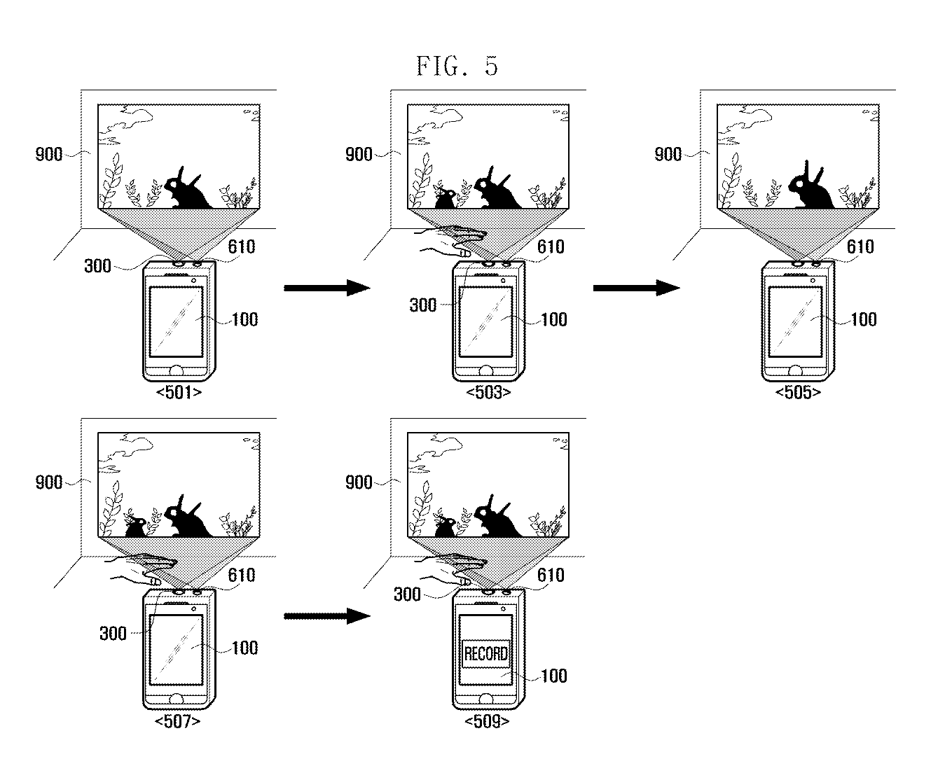

FIG. 5 is a view illustrating one example of controlling an external output according to a user interaction detected by a first image sensing module of a mobile device in accordance with an exemplary embodiment of the present invention. FIG. 5 shows an example in which the external screen data of content played by a game application is updated according to a user interaction. In this example, the content is what is called ‘a shadow play’.

Referring to FIG. 5, in a first state 501, screen data of the shadow play content is outputted through the projector module 300 of the mobile device and then projected onto the external screen 900. The external screen data on the external screen 900 may be real screen data played according to the execution of the shadow play content, and the internal screen data on the display unit 100 may be manipulation information, guide information and execution information about the specific content, the shadow play. Alternatively, the display unit 100 may be in the off-state according to a setting policy or user's selection.

The user may produce a user interaction for controlling the external screen data. For example, as shown in the second state 503, the user's hand may intervene between the mobile device and the external screen 900. The user may place the hand within the recognizable range of the first image sensing module 610 between the mobile device and the external screen 900.

The first image sensing module 610 detects a user gesture (i.e., intervention of the hand) as a user interaction and then transmits resultant interaction information to the control unit 700. When a user interaction based on the first image sensing module 610 is detected during a play of the shadow play content, namely when interaction information is received from the first image sensing module 610, the control unit 700 identifies a particular function mapped to a current application or content and thereby controls an update of the external screen data. For example, as shown in a third state 505, the control unit 700 removes a specific object from the external screen data and thereby creates updated screen data. The projector module 300 projects the updated screen data onto the external screen 900 under the control of the control unit 700. In the end, a left object 50 contained in the external screen data in the second state 503 is removed from the external screen data in the third state 505.

In the second and third states 503 and 505, the internal screen data displayed on the display unit 100 may also be varied. For example, the internal screen data in the second state 503 may be execution information about current content, the shadow play, and the internal screen data in the third state 505 may be manipulation information about the updated external screen data. A policy of displaying the internal screen data may be set up by a user or offered as default.

The user may further produce another user interaction for reconfiguring the external screen data. For example, as shown in a fourth state 507, the user may again place the hand between the mobile device and the external screen 900. A hand-resembling shadow is formed on the external screen data because of the interception of projection by the hand between the projector module 300 and the external screen 900. This hand-resembling shadow creates a new object in the external screen data on the external screen 900.

The first image sensing module 610 detects a user gesture (i.e., intervention of the hand) as a user interaction and then sends resultant interaction information to the control unit 700. When a user interaction based on the first image sensing module 610 is detected after an output of the updated screen data, namely when interaction information is received from the first image sensing module 610, the control unit 700 identifies a particular function mapped to a current application or content and thereby performs that function. For example, as shown in the fifth state 509, the control unit 700 enables the first image sensing module 610 to acquire a combination image of the external screen data and a new object created by a user gesture and then records the acquired image. The control unit 700 may also offer execution information indicating the execution of a recording function to the display unit 100.

As discussed above with reference to FIG. 5, the control unit 700 according to an exemplary embodiment of the present invention may recognize a user interaction based on the first image sensing module 610 during the execution of a game application such as the shadow play. The control unit 700 may remove a predefined of object from the shadow play content and thereby output the updated external screen data through the projector module 300.

In addition, the control unit 700 may recognize another user interaction based on the first image sensing module 610 after outputting the updated external screen data. The control unit 700 may control a recording function to acquire and store, through the first image sensing module 610, a combination image of the external screen data projected on the external screen 900 and a new object created by a user gesture.

According to the exemplary embodiment shown in FIG. 5, the user can allow a new object to be created instead of an existing object on the external screen data by making a desired gesture. By forming a shadow with the hand on the external screen data, a user can actively enjoy the shadow play content. Accordingly, a user can use the current content in a desired way through various shapes and movements of the hand and can also create a new configuration of content with which a hand-resembling shadow object is combined.

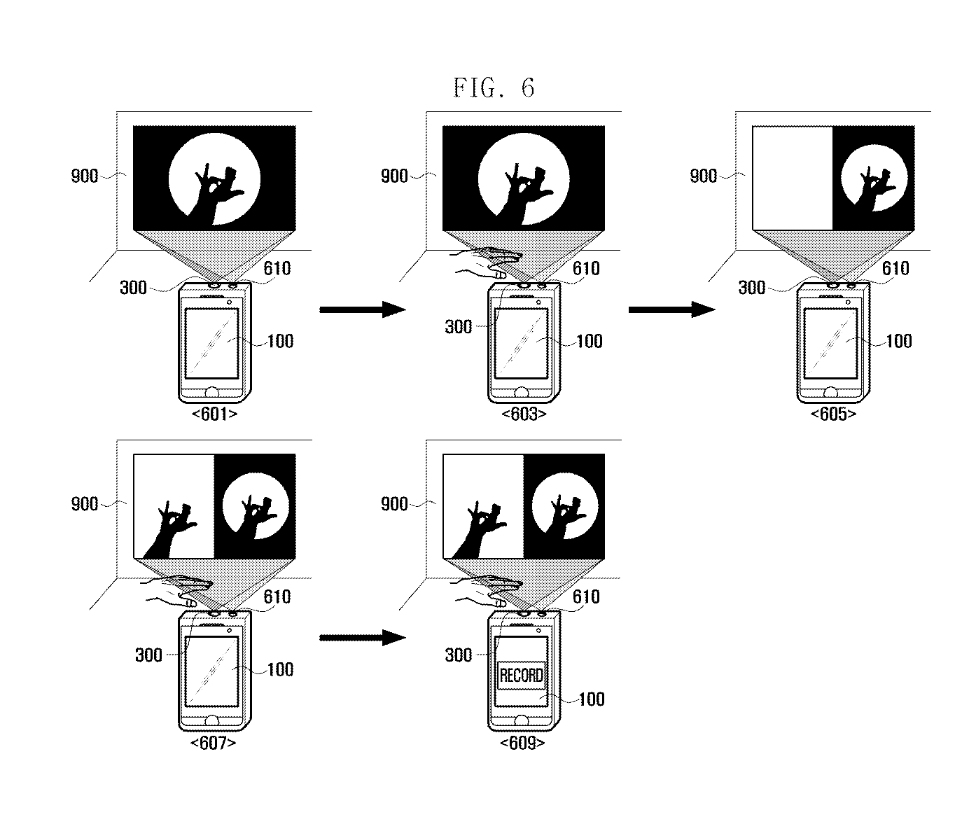

FIG. 6 is a view illustrating another example of controlling an external output according to a user interaction detected by a first image sensing module of a mobile device in accordance with an exemplary embodiment of the present invention. FIG. 6 shows another example in which the external screen data of content played by a game application is updated according to a user interaction. In this example, the content is what is called ‘a shadow tutorial’.

Referring to FIG. 6, in a first state 601, screen data of the shadow tutorial content is outputted through the projector module 300 of the mobile device and then projected onto the external screen 900. The external screen data on the external screen 900 may be real screen data played according to the execution of the shadow tutorial content, and the internal screen data on the display unit 100 may be manipulation information, guide information and execution information about the shadow tutorial content. Alternatively, the display unit 100 may be in the off-state according to a setting policy or user's selection.

The user may produce a user interaction for controlling the external screen data. For example, as shown in a second state 603, the user's hand may intervene between the mobile device and the external screen 900. The user may place the hand within the recognizable range of the first image sensing module 610 between the mobile device and the external screen 900.

The first image sensing module 610 detects a user gesture (i.e., intervention of the hand) as a user interaction and sends resultant interaction information to the control unit 700. When a user interaction based on the first image sensing module 610 is detected during a play of the shadow tutorial content, namely when interaction information is received from the first image sensing module 610, the control unit 700 identifies a particular function mapped to a current application or content and thereby controls an update of the external screen data.

For example, as shown in a third state 605, the control unit 700 divides an output region of the external screen data into two or more parts. As shown in FIG. 6, the output region is divided into two parts. The control unit 700 presents one of the divided parts as a blank region (hereinafter referred to as the first region) and presents the other divided part as a resized region (hereinafter referred to as the second region) of the external screen data. As shown in FIG. 6, the control unit 700 outputs the first half of the entire region as a blank region (the first region) and also outputs the second half as a resized region (the second region) of the external screen data. Through a resizing, the external screen data is adjusted to conform to the size of the second region. For example, the size of the external screen data is maintained in height but reduced in width.

The projector module 300 projects the updated screen data onto the external screen 900 under the control of the control unit 700. In the end, the output region of the external screen data in the second state 603 is divided into two regions in the third state 605, one of which outputs the resized screen data of the shadow tutorial content.

In the second and third states 603 and 605, the internal screen data displayed on the display unit 100 may also be varied. For example, the internal screen data in the second state 603 may be execution information about current content, the shadow tutorial, and the internal screen data in the third state 605 may be manipulation information about the updated external screen data. A policy of displaying the internal screen data may be set up by a user or offered as default.

The user may further produce another user interaction for reconfiguring the external screen data. For example, as shown in a fourth state 607, a user may again place the hand between the mobile device and the external screen 900. A hand-resembling shadow is formed on a specific region (e.g., the first region) of the external screen data because of the interception of projection by the hand between the projector module 300 and the external screen 900. This hand-resembling shadow creates a new object in the external screen data on the external screen 900.

The first image sensing module 610 detects a user gesture (i.e., intervention of the hand) as a user interaction and then sends resultant interaction information to the control unit 700. When a user interaction based on the first image sensing module 610 is detected after an output of the updated screen data, namely when interaction information is received from the first image sensing module 610, the control unit 700 identifies a particular function mapped to a current application or content and thereby performs that function. For example, as shown in a fifth state 609, the control unit 700 enables the first image sensing module 610 to acquire a combination image of the external screen data and a new object created by a user gesture and then records the acquired image. The control unit 700 may also offer execution information indicating the execution of a recording function to the display unit 100.

As discussed above with reference to FIG. 6, the control unit 700 according to an exemplary embodiment of the present invention may recognize a user interaction based on the first image sensing module 610 during the execution of a game application such as the shadow tutorial. The control unit 700 may determine divided regions and then perform a resizing process so that the external screen data of the shadow tutorial content can be adjusted to conform to the size of the divided region. The control unit 700 may output the resized screen data onto the external screen 900 through the projector module 300. Through an output control based on a division of regions by the control unit 700, the output region on the external screen 900 is divided into the first region and the second region.

In addition, the control unit 700 may recognize another user interaction based on the first image sensing module 610 after outputting the updated external screen data. The control unit 700 may control a recording function to acquire and store, through the first image sensing module 610, a combination image of the external screen data projected on the external screen 900 and a new object created by a user gesture.

According to the exemplary embodiment shown in FIG. 6, the user can allow a new object to be projected onto the first region in blank by making a desired gesture. Referring to a given shadow of the external screen data offered in the second region, a user can try to make a similar hand gesture that forms a resultant shadow in the first region. Accordingly, a user can learn how to make a specific shadow. The user can use the current content while comparing a shadow of the hand formed in the first region with a given shadow offered in the second region, and also can create a new configuration of content to which a shadow object in the first region is added.

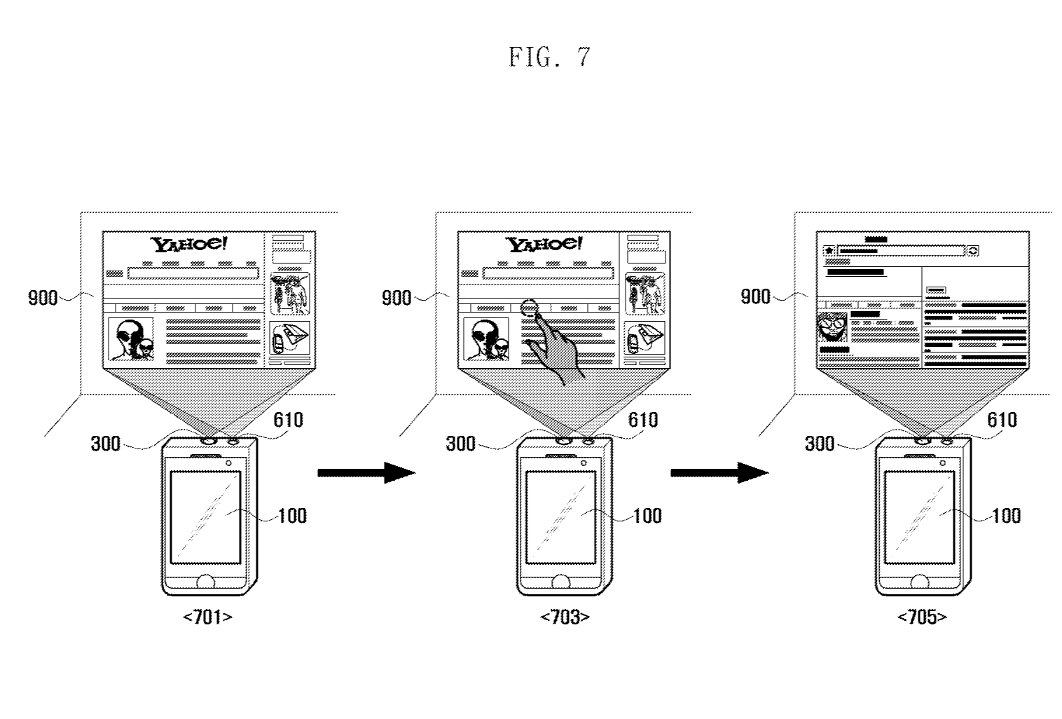

FIG. 7 is a view illustrating an example of controlling an external output according to a user interaction detected by a first image sensing module of a mobile device in accordance with an exemplary embodiment of the present invention. FIG. 7 shows an example in which the external screen data of content outputted by a browser application is updated according to a user interaction. In this example, the external screen data is a web page having various links.

Referring to FIG. 7, in a first state 701, a web page offered by the browser application is outputted through the projector module 300 of the mobile device and then projected onto the external screen 900. The external screen data on the external screen 900 may be a certain web page offered from a specific web server according to the execution of the browser application, and the internal screen data on the display unit 100 may be the same web page as the external screen data or a modified web page adapted to the mobile device. Alternatively, the display unit 100 may be in the off-state according to a setting policy or user's selection.

The user may produce a user interaction for controlling the external screen data. For example, as shown in a second state 703, the user may point out a certain spot on the external screen 900 by means of a certain pointing tool (e.g., the finger, a laser pointer, a baton, etc.). The user may indicate a certain point in a web page by using such a tool within the recognizable range of the first image sensing module 610 between the mobile device and the external screen 900.

The first image sensing module 610 detects a user gesture (i.e., pointing out of a certain spot) as a user interaction and then sends resultant interaction information to the control unit 700. When a user interaction is detected, the first image sensing module 610 may take a photograph to acquire an image of the external screen data on the external screen 900 under the control of the control unit 700 and then send the acquired image as interaction information. When a user interaction based on the first image sensing module 610 is detected in the external output mode, namely when interaction information is received from the first image sensing module 610, the control unit 700 extracts a particular function corresponding to the received interaction information and thereby controls an update of the external screen data. For example, as shown in a third state 705, the control unit 700 produces a new web page in response to a user interaction and controls the output of the projector module 300. The projector module 300 projects the updated screen data onto the external screen 900 under the control of the control unit 700. In the end, a web page offered in the second state 703 is changed to a new web page offered in the third state 705.

When interaction information is received from the first sensing module 610, the control unit 700 may compare the received interaction information with screen data offered to the projector module 300. The control unit 700 may extract, in an intercept manner, the screen data offered to the projector module 300. The control unit 700 may extract the screen data buffered for the external output through the projector module 300 and then compare the extracted screen data (hereinafter, referred to as original screen data) with other screen data (hereinafter, referred to as acquired screen data) based on the received interaction information which is earlier acquired by taking a photograph.

Through the comparison of the original screen data and the acquired screen data, the control unit 700 may find a modified part. The control unit 700 extracts a specific spot selected by a pointing tool on the modified part of the acquired screen data. The control unit 700 may extract the pointed-out spot by using a suitable algorithm such as a facial recognition algorithm. If such a spot is indicated by a certain color through a laser pointer or marker, the control unit 700 may extract the indicated spot by using a color recognition algorithm. The control unit 700 computes location information (e.g., a coordinate value or any other recognizable data) about the extracted spot and obtains link information assigned to the location information in the original screen data.

The control unit 700 may control an access to a specific web server corresponding to the link information and send a web page offered by the accessed web server to the projector module 300. The projector module 300 may project the received web page as updated screen data onto the external screen 900 under the control of the control unit 700. A web page in the second state 703 may be updated to a new web page in the third state 705.

According to the exemplary embodiment shown in FIG. 7, the user can make a user interaction through a certain pointing tool on the external screen data projected onto the external screen 900. Such a user interaction pointing out a certain spot on the external screen 900 may achieve a similar effect when the display unit 100 is directly touched. Only a user interaction on the external screen 900 may make it possible to move to a selected link.

In the second and third states 703 and 705, the internal screen data displayed on the display unit 100 may also be varied. For example, the internal screen data in the second state 703 may be the original screen data before a move to a selected link, and the internal screen data in the third state 705 may be the updated screen data after a move to a selected link. A policy of displaying the internal screen data may be set up by a user or offered as default.

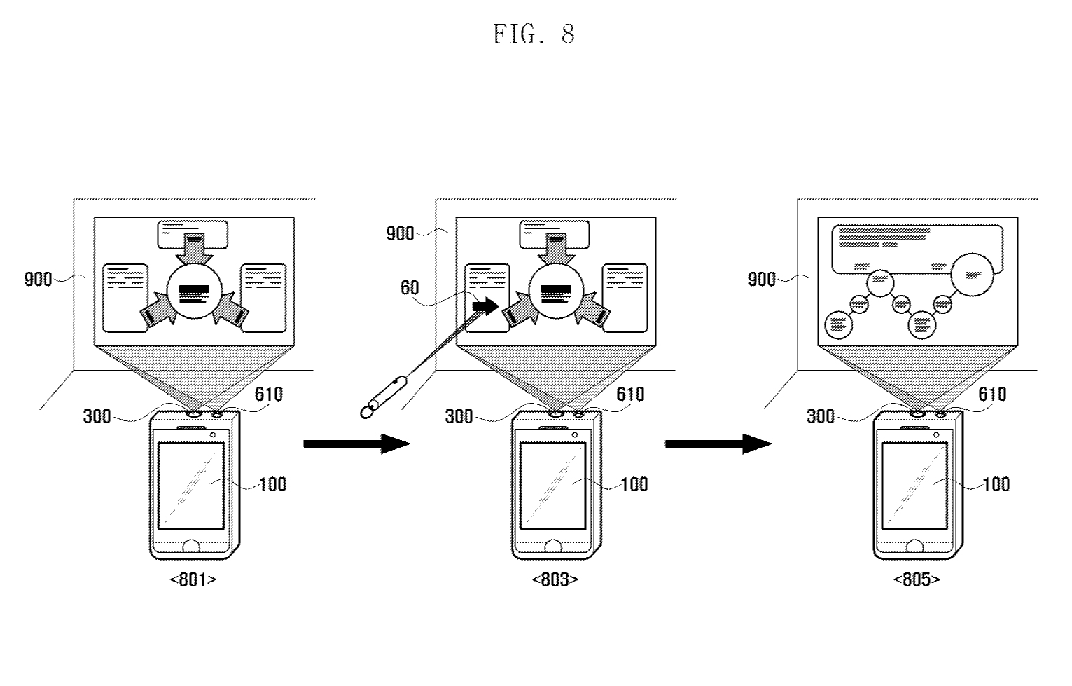

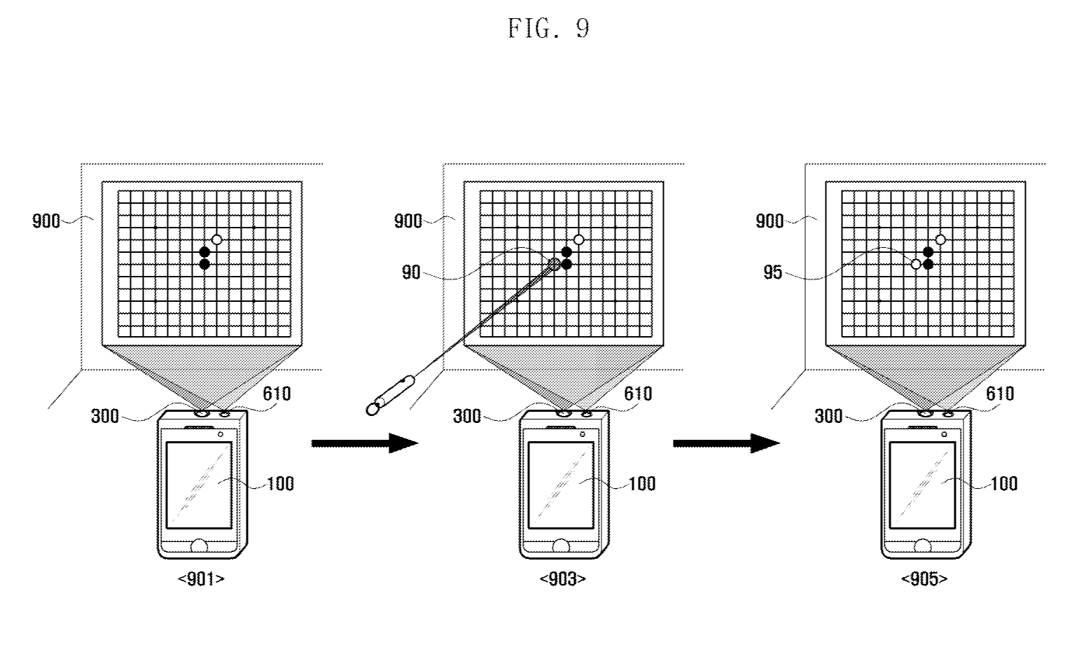

FIG. 8 is a view illustrating an example of controlling an external output according to a user interaction detected by a first image sensing module of a mobile device in accordance with an exemplary embodiment of the present invention. FIG. 8 shows an example in which the external screen data of content outputted by a presentation application is updated according to a user interaction. In this example, the external screen data is a certain document page.

Referring to FIG. 8, in a first state 801, a certain document page offered by the representation application is outputted through the projector module 300 of the mobile device and then projected onto the external screen 900. The external screen data on the external screen 900 may be a page of a certain document opened according to the execution of the presentation application, and the internal screen data on the display unit 100 may be the same document page as the external screen data or a viewer version of the same document page rather than a presentation version. Alternatively, the display unit 100 may be in the off-state according to a setting policy or user's selection.

The user may produce a user interaction for controlling the external screen data. For example, as shown in a second state 803, the user may produce a distinguishably shaped or colored point 60 at a certain spot on the external screen 900 via a certain pointing tool (e.g., a laser pointer). The user may indicate a certain point in a document page by using such a tool within the recognizable range of the first image sensing module 610 between the mobile device and the external screen 900.

The first image sensing module 610 detects the formation of the distinguishable point 60 as a user interaction and then sends resultant interaction information to the control unit 700. When interaction information is received from the first image sensing module 610 in the external output mode, the control unit 700 extracts a particular function corresponding to the received interaction information and thereby controls an update of the external screen data. For example, as shown in a third state 805, the control unit 700 turns over the document page in response to a user interaction and controls the output of the projector module 300. The projector module 300 projects the updated screen data onto the external screen 900 under the control of the control unit 700. In the end, a document page offered in the second state 803 is changed to a new document page offered in the third state 805.

According to the exemplary embodiment shown in FIG. 8, a user can make a user interaction through a laser pointer, etc. on the external screen data projected onto the external screen 900. The user interaction may be to form a distinguishably shaped or colored point 60 through a laser pointer. By changing distinguishable shapes or colors of the point 60, the user can request a move to a previous page or to a next page. The control unit 700 may analyze interaction information received from the first image sensing module 610, extract a particular function mapped to a specific shape or color of the point according to the analyzed interaction information, and then produce updated screen data according to the extracted function. In addition, the control unit 700 may send the updated screen data to the projector module 300 and then control the external output.

In the second and third states 803 and 805, the internal screen data displayed on the display unit 100 may also be varied. For example, the internal screen data in the second state 803 may be a viewer version of a document page before a turning over of a page, and the internal screen data in the third state 805 may be a viewer version of another document page after a turning over of a page. A policy of displaying the internal screen data may be set up by a user or offered as default.

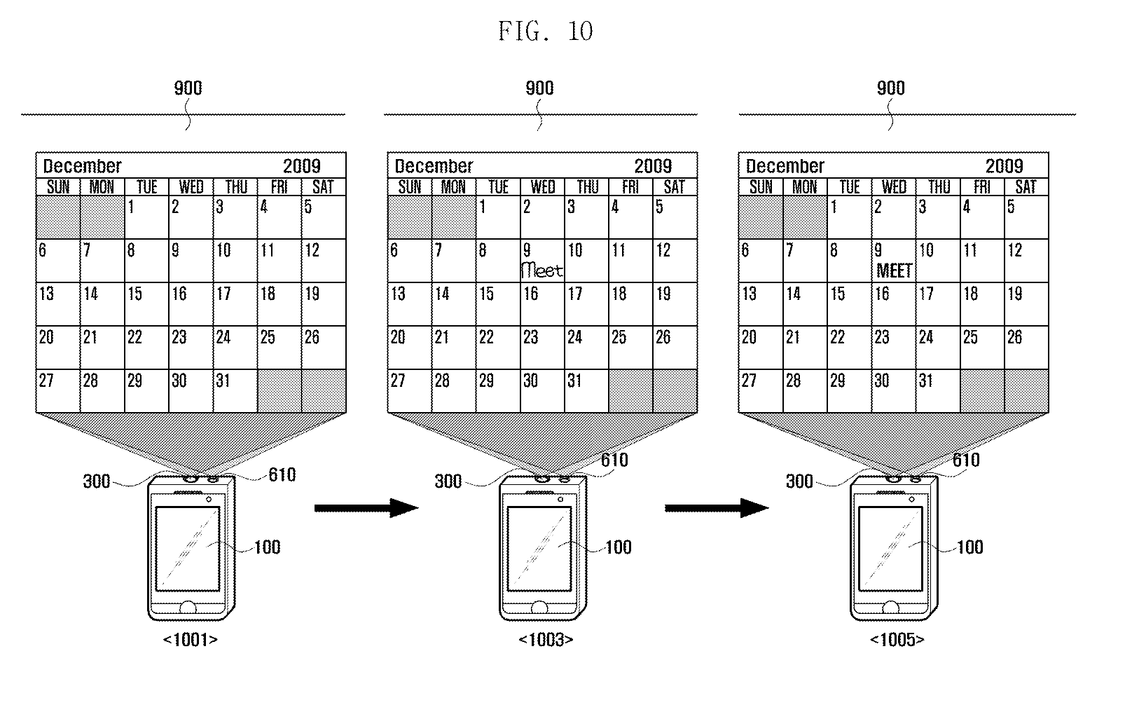

FIG. 9 is a view illustrating an example of controlling an external output according to a user interaction detected by a first image sensing module of a mobile device in accordance with an exemplary embodiment of the present invention. FIG. 9 shows an example in which the external screen data of content played by a game application is updated according to user interaction. In this example, the external screen data is a certain image of game content (e.g., a board game).

Referring to FIG. 9, in a first state 901, an image of a selected board game is outputted through the projector module 300 of the mobile device and then projected onto the external screen 900. The external screen data on the external screen 900 may be a certain image of a selected board game activated according to the execution of the board game content, and the internal screen data on the display unit 100 may be manipulation information, guide information and execution information about the selected board game. Alternatively, the display unit 100 may be in the off-state according to a setting policy or user's selection.

The user may produce a user interaction for controlling the external screen data. For example, as shown in a second state 903, a user may produce a predefined point 90 at a certain spot on the external screen 900 via a certain pointing tool (e.g., the hand, a laser pointer, a marker, etc.). The user may indicate a desired point in a certain image of the board game by using such a tool within the recognizable range of the first image sensing module 610 between the mobile device and the external screen 900.

The first image sensing module 610 detects the formation of the predefined point 90 as a user interaction and then sends resultant interaction information to the control unit 700. When interaction information is received from the first image sensing module 610 in the external output mode, the control unit 700 extracts a particular function corresponding to the received interaction information and thereby controls an update of the external screen data. For example, the control unit 700 recognizes a formation location of the predefined point from a user interaction and extracts a particular function mapped to the recognized location. As shown in a third state 905, the control unit 700 produces a predefined object 95 at the recognized location according to the extracted function and controls the output of the projector module 300. The projector module 300 projects the updated screen data onto the external screen 900 under the control of the control unit 700. In the end, a certain image of the board game offered in the second state 903 is changed to a new image containing the produced object 95 in the third state 905.

According to the exemplary embodiment shown in FIG. 9, a user can make a user interaction through a laser pointer, etc. on the external screen data projected onto the external screen 900. The user interaction may be to form a predefined point 90 at a desired spot by using a laser pointer, a marker, the finger, etc. By indicating different spots, the user can enjoy the board game. The control unit 700 may analyze interaction information received from the first image sensing module 610, recognize a specific location indicated by the received interaction information, and then perform a particular function mapped to the recognized location. For example, the predefined object 95 is produced at the indicated location. In addition, the control unit 700 may send the updated screen data to the projector module 300 and then control the external output.

In the second and third states 903 and 905, the internal screen data displayed on the display unit 100 may also be varied. For example, the internal screen data in the second state 903 may be information about manipulation, guide and execution of the selected board game in a certain image, and the internal screen data in the third state 905 may be information about further manipulation, guide and execution of that board game in a new image containing the produced object 95. A policy of displaying the internal screen data may be set up by a user or offered as default.

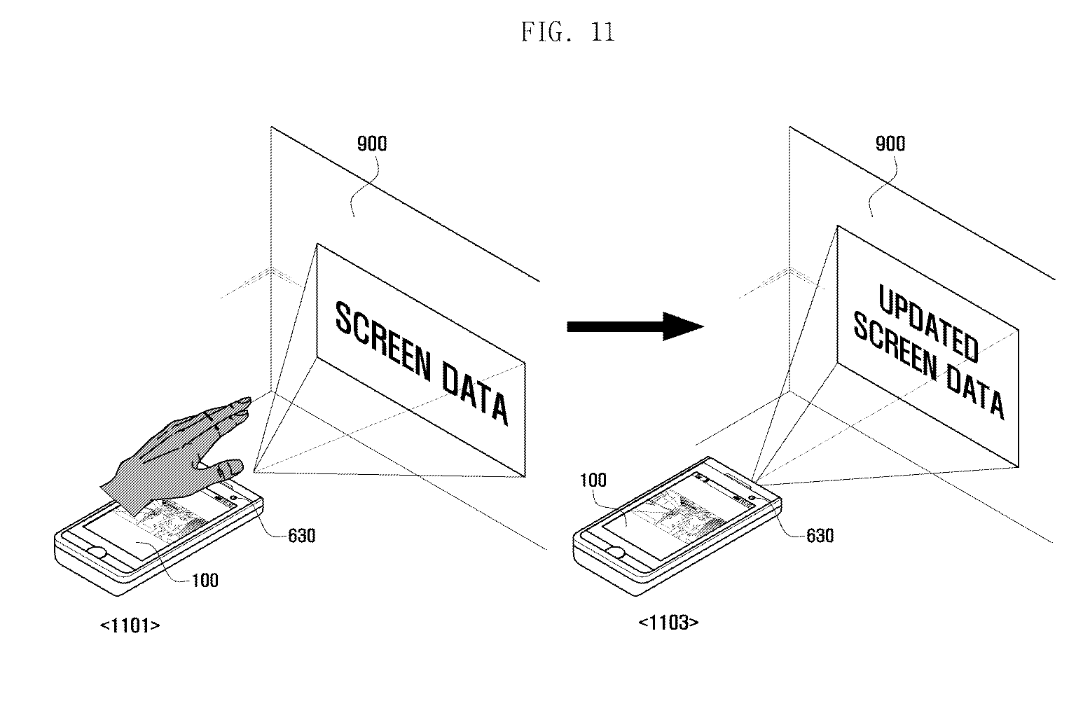

FIG. 10 is a view illustrating an example of controlling an external output according to a user interaction detected by a first image sensing module of a mobile device in accordance with an exemplary embodiment of the present invention. FIG. 10 shows an example in which the external screen data of content played by a scheduler application is updated according to a user interaction. In this example, the external screen data is a calendar or schedule table.

Referring to FIG. 10, in a first state 1001, a calendar image is outputted through the projector module 300 of the mobile device and then projected onto the external screen 900. The external screen data on the external screen 900 may be a calendar image or schedule table activated according to the execution of the scheduler content, and the internal screen data on the display unit 100 may be menu information, manipulation information and schedule information about the scheduler content. Alternatively, the display unit 100 may be in the off-state according to a setting policy or user's selection.

The user may produce a user interaction for controlling the external screen data. For example, as shown in the second state indicated by a reference number 1003, the user may produce some letters on the external screen 900. The user may write letters (e.g., “meet”) in a selected region on the calendar image by using the finger or a marker within the recognizable range of the first image sensing module 610 between the mobile device and the external screen 900.

The first image sensing module 610 detects the input of letters as a user interaction and then sends resultant interaction information to the control unit 700. When the interaction information is received from the first image sensing module 610 in the external output mode, the control unit 700 extracts a particular function corresponding to the received interaction information and thereby controls an update of the external screen data. For example, the control unit 700 recognizes inputted letters and their location from the user interaction. As shown in a third state 1005, the control unit 700 produces an updated screen data having a new object corresponding to inputted letters. Then the projector module 300 projects the updated screen data onto the external screen 900 under the control of the control unit 700. In the end, some letters written in the second state 1003 is inserted into a calendar image as shown in the third state 1005.

The above process of an update control for the external screen data according to interaction information received from the first image sensing module 610 may include comparing the original screen data with the acquired screen data, recognizing a modified part, and processing based on the modified part as discussed in FIG. 7. For example, the control unit 700 may compare the original screen data with interaction information periodically received from the first image sensing module 610, and thereby may find letters inputted. The control unit 700 may insert the inputted letters into the scheduler content and thereby produce updated screen data. The control unit 700 may also output externally or store internally the updated screen data.

According to the exemplary embodiment shown in FIG. 10, a user can simply make a user interaction through an input of letters on the external screen data projected onto the external screen 900. The user interaction may be to write some letters by using the finger, etc. The control unit 700 may analyze interaction information received from the first image sensing module 610, recognize a specific location indicated by the received interaction information, and then perform a particular function mapped to the recognized location. This example may achieve a similar effect when a user directly uses a scheduler function in the mobile device. In addition, the control unit 700 may send the updated screen data to the projector module 300 and then control the external output.

In the second and third states 1003 and 1005, the internal screen data displayed on the display unit 100 may also be varied. For example, the internal screen data in the second state 1003 may be information about manipulation, guide and execution of the scheduler content, and the internal screen data in the third state 1005 may be the updated screen data containing the inputted letters. A policy of displaying the internal screen data may be set up by a user or offered as default.

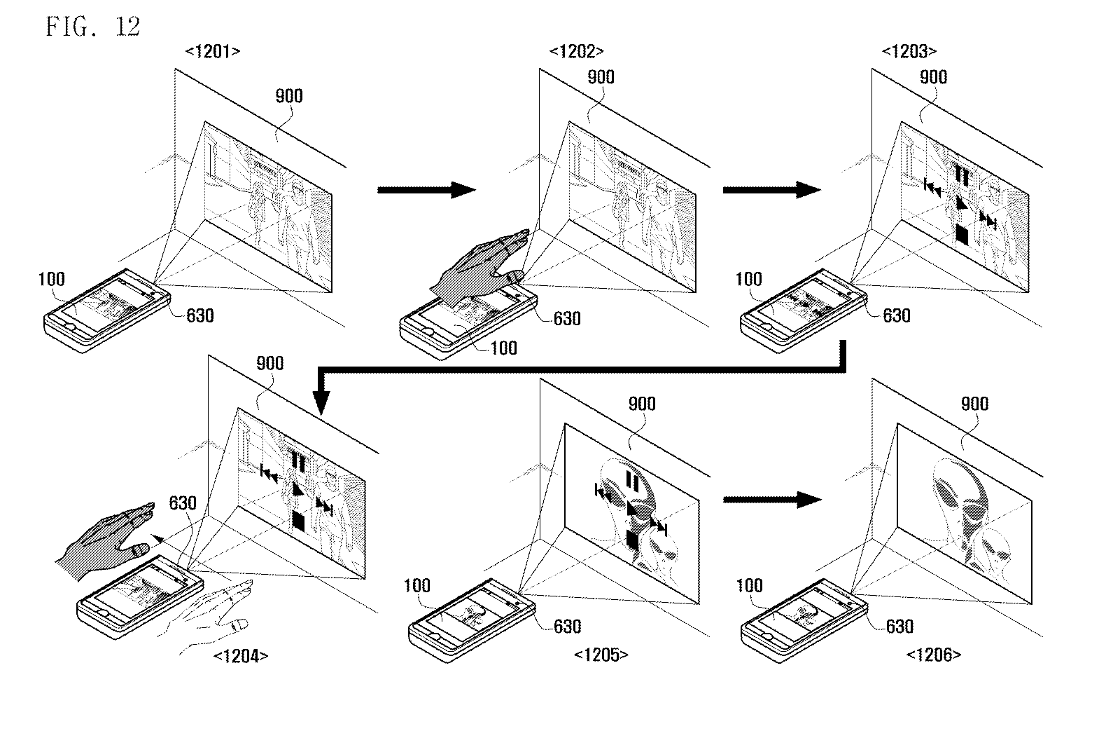

Described above with reference to FIGS. 4 to 10 are several examples in which the first image sensing module 610 detects a user interaction occurring between the mobile device and the external screen 900 and thereby the control unit 700 controls the external output according to the detected user interaction. Described below with reference to FIGS. 11 to 13 are examples in which the second image sensing module 630 detects a user interaction occurring around the mobile device and thereby the external output is controlled according to the detected user interaction.

FIG. 11 is a view illustrating a control method according to a user interaction occurring around a mobile device in accordance with another exemplary embodiment of the present invention.

Referring to FIG. 11, in an initial state 1101, screen data of specific content is outputted through the projector module 300 of the mobile device and then projected onto the external screen 900. According to the user's manipulation, the mobile device executes a specific application and then outputs screen data related to the specific application to the external screen 900 through an external output function based on the projector module 300. Screen data may include dynamic screen data of content played or executed by various player applications (e.g., a video player application, a digital broadcast player application, a game application, etc.), and static screen data of contents displayed by various viewer applications (e.g., a text viewer application, an image viewer application, an e-book viewer application, etc.).

In the initial state 1101, the user may produce an interaction for a control of screen data being outputted. For example, the user may produce a certain user interaction within the recognizable range of the second image sensing module 630 around the mobile device. As discussed above, this user interaction may include some predefined user gestures (e.g., a sweep or any other hand motions) that are made around the mobile device and can be recognized by the second image sensing module 630. Detailed examples will be described later.

The second image sensing module 630 detects a user interaction and delivers resultant interaction information to the control unit 700. The control unit 700 identifies the interaction information received from the second image sensing module 630. The control unit 700 further identifies a particular function corresponding to the interaction information and controls an external output according to the particular function. The control unit 700 controls selected content according to a particular function based on interaction information, and also controls the output of screen data modified thereby. In the next state 1103, updated screen data is offered to the external screen 900. Related examples will be described later with reference to the drawings.

When the mobile device is in the external output mode, the display unit 100 may be in the on-state (namely, enabled) or in the off-state (namely, disabled) according to a setting policy. If the display unit 100 is in the on-state, the internal screen data displayed on the display unit 100 may be identical to or different from the external screen data projected onto the external screen 900. For example, the external screen data may be screen data of content played by the execution of a specific application, and the internal screen data may be screen data offering manipulation information about content, content information, execution information, and the like.

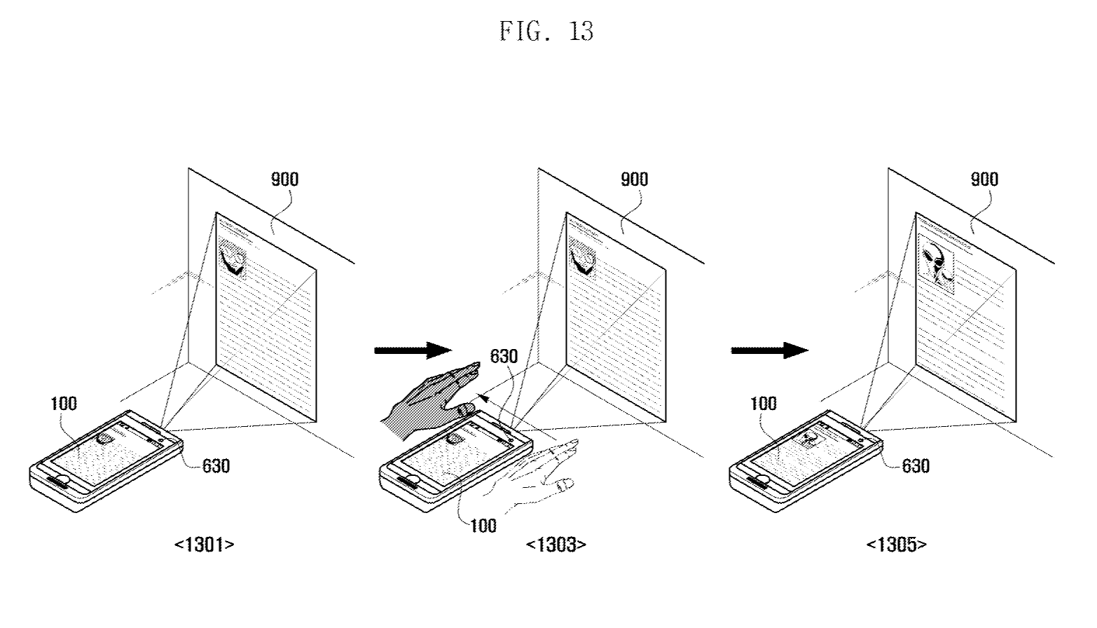

FIG. 12 is a view illustrating one example of controlling an external output according to a user interaction detected by a second image sensing module of a mobile device in accordance with an exemplary embodiment of the present invention. FIG. 12 shows an example in which the external screen data of content played by a certain player application is updated according to a user interaction. In this example, content is video content or digital broadcast content.

Referring to FIG. 12, in a first state 1201, screen data of selected content is outputted through the projector module 300 of the mobile device and then projected onto the external screen 900. The external screen data on the external screen 900 may also be displayed on the display unit 100. Alternatively, the display unit 100 may be in the off-state according to a setting policy or user's selection.

The user may produce a user interaction for controlling the external screen data. For example, as shown in a second state 1202, the user may locate the hand at any place or make a sweep gesture around the mobile device within the recognizable range of the second image sensing module 630.

The second image sensing module 630 detects a user gesture (i.e., presence of the hand or sweep gesture) as a user interaction and sends resultant interaction information to the control unit 700. When a user interaction based on the second image sensing module 630 is detected during a play of the selected content, namely when interaction information is received from the second image sensing module 630, the control unit 700 identifies a particular function mapped to a current application or content and thereby controls an update of the external screen data. For example, as shown in a third state 1203, the control unit 700 produces virtual items for a control of play-related functions and then outputs them to the projector module 300. The projector module 300 projects the updated screen data onto the external screen 900 under the control of the control unit 700. In the end, the updated screen data containing such virtual items is outputted in the third state 1203. Virtual items may be contained in at least one of the internal screen data and the external screen data.

The user may further produce another user interaction for a control of play-related functions. For example, as shown in a fourth state 1204, the user may refer to virtual items and make a user interaction for controlling a particular function around the mobile device. The user interaction may be caused by an upward sweep gesture, a downward sweep gesture, a rightward sweep gesture, a leftward sweep gesture, etc. near the second image sensing module 630. The second image sensing module 630 detects such a user gesture as a user interaction and sends resultant interaction information to the control unit 700.

When a user interaction based on the second image sensing module 630 is detected while the content is played, namely when interaction information is received from the second image sensing module 630, the control unit 700 identifies a particular function mapped to a current application or content and thereby performs that function. For example, the control unit 700 may perform a fast-forward function in response to a corresponding user interaction and thereby control the external output based on the projector module 300. The projector module 300 may project the updated screen data onto the external screen 900 under the control of the control unit 700. As shown in the fifth state 1205, a next image may be outputted according to the fast-forward function.

If the screen data is a video image and if the detected interaction information is for a control of the fast-forward function, the control unit 700 may sequentially shift the outputted screen data while the fast-forward function is performed. Similarly, other various functions may be executed, such as a channel shift, a volume adjustment, a pause, a rewind, a zooming, a page shift, an image slide, a screen shift, a scroll, navigation, and the like.

Although not illustrated in FIG. 12, the control unit 700 may also visually offer execution information for indicating that a particular function is executed according to interaction information. For example, the control unit 700 may output execution information such as icon, text, etc. on at least one of the internal screen data and the external screen data for a given time or during a function control. This execution information may disappear after a given time or when a current function is terminated.

After a selected function control for the external output is completed, the screen data may continue to play. If new interaction information is not received for a given time, the control unit 700 may remove the virtual items outputted on at least one of the internal screen data and the external screen data, as shown in a sixth state 1206. Alternatively, the control unit 700 may remove the virtual items in response to a predefined user interaction.

FIG. 13 is a view illustrating an example of controlling an external output according to a user interaction detected by a second image sensing module of a mobile device in accordance with an exemplary embodiment of the present invention. FIG. 13 shows an example in which the external screen data outputted by the execution of a presentation application is updated according to a user interaction. In this example, the external screen data is a certain document page.

Referring to FIG. 13, in a first state 1301, a document page is outputted through the projector module 300 of the mobile device and then projected onto the external screen 900. The document page may also be displayed on the display unit 100. Alternatively, the display unit 100 may be in the off-state according to a setting policy or user's selection.

The user may produce a user interaction for controlling the external screen data. For example, as shown in a second state 1303, the user may locate the hand at any place or make a sweep gesture around the mobile device within the recognizable range of the second image sensing module 630.

The second image sensing module 630 detects a user gesture (i.e., presence of the hand or sweep gesture) as a user interaction and sends resultant interaction information to the control unit 700. When a user interaction based on the second image sensing module 630 is detected during a control of the external output, namely when interaction information is received from the second image sensing module 630, the control unit 700 identifies a particular function mapped to a current application and thereby controls an update of the external screen data. For example, as shown in a third state 1305, the control unit 700 may control a page shift in response to a user interaction and then output the shifted page to the projector module 300. The projector module 300 projects the updated screen data onto the external screen 900 under the control of the control unit 700. In the end, a document page offered in the second state 1303 is changed to a new document page offered in the third state 1305.

According to the exemplary embodiment shown in FIG. 13, during a presentation using the external output function, the user can perform a desired function control such as a move to next pages or previous pages by making a user interaction such as a sweep gesture based on the second image sensing module 630. The control unit 700 may analyze interaction information received from the second image sensing module 630, extract a particular function mapped to the analyzed interaction information, and then produce the updated screen data according to the extracted function. In addition, the control unit 700 may send the updated screen data to the projector module 300 and then control the external output.

Although not illustrated in FIG. 13, the control unit 700 may also visually offer execution information for indicating that a particular function is executed according to interaction information. For example, the control unit 700 may output execution information, such as icon, text, etc. on at least one of the internal screen data and the external screen data for a given time or during a function control. This execution information may disappear after a given time or when a current function is terminated.

The user may further produce another user interaction for a control of another function. The control unit 700 may sequentially control the output of the updated screen data in response to another user interaction.

Although omitted in the examples shown in FIGS. 11 to 13, the second image sensing module 630 may be replaced with a proximity sensing module such as a proximity sensor, a light sensor, etc. Additionally, the first image sensing module 610 shown in FIGS. 4 to 10 may be used together with the second image sensing module 630 shown in FIGS. 11 to 13 and thereby various functions earlier discussed in FIGS. 4 to 13 may be used together. For example, in the external output mode of the mobile device, the user can produce a user interaction based on the first image sensing module 610 to control specific functions discussed in FIGS. 4 to 10 and also can produce another user interaction based on the second image sensing module 630 to control specific functions discussed in FIGS. 11 to 13.

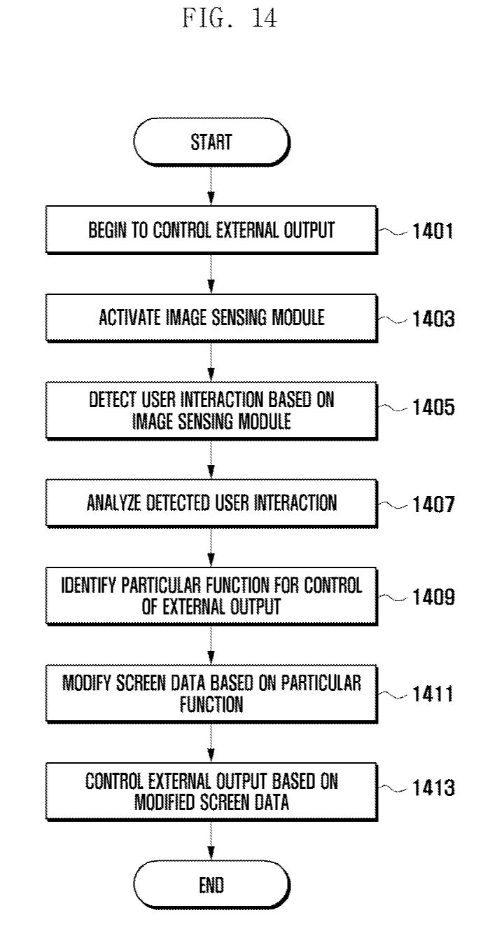

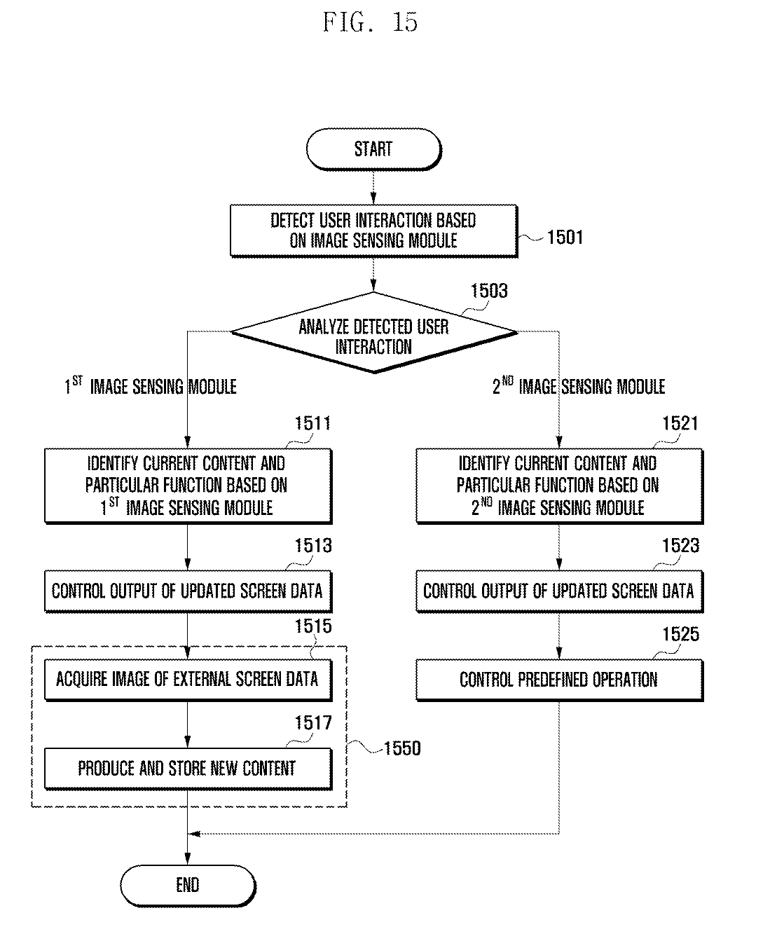

Several examples are described above in which the mobile device receives a user interaction based on the image sensing module and then controls the external output of the updated screen data according to the received user interaction. Control methods for the external output in the mobile device are described below with respect to FIGS. 14 and 15. However, the following embodiments are exemplary only and not to be considered as a limitation of the present invention. Alternatively, other embodiments could be used without departing from the scope of the present invention.

FIG. 14 is a flow diagram illustrating a method for controlling an external output according to a user interaction based on an image sensing module of a mobile device in accordance with an exemplary embodiment of the present invention.

Referring to FIG. 14, a projector function of the mobile device is activated by user input via, for example, the input unit 200, the display unit 100, and the microphone (MIC). The control unit 700 drives the projector module 300 in response to a user's request and begins to control the external output of screen data of a selected application so that the screen data can be projected onto the external screen 900 through the projector module 300 in step 1401. The selected application may be executed before the projector module 300 is driven, and also the screen data thereof may be displayed in the display unit 100. A selected application may be executed at the same time when the projector module 300 is driven, and the screen data thereof may be simultaneously output to both the display unit 100 and the external screen 900. A selected application may also be executed at a user's request after the projector module 300 is driven, and the screen data thereof may be simultaneously output to both the display unit 100 and the external screen 900.

The control unit 700 activates the image sensing module 600 in step 1403. In this step, the image sensing module 600 may be at least one of the first image sensing module 610 discussed in FIGS. 4 to 10 and the second image sensing module 630 discussed in FIGS. 11 to 13. The control unit 700 may automatically activate the image sensing module 600 when the projector module 300 is driven. Alternatively, the control unit 700 may activate the image sensing module 600 in response to a suitable input signal. The control unit 700 complies with predefined setting information about the activation of the image sensing module 600.

The control unit 700 detects a user interaction inputted through the image sensing module 600 during the external output in step 1405. The image sensing module 600 detects user interaction for a control of the external output and then sends interaction information about the detected user interaction to the control unit 700. By receiving the interaction information from the image sensing module 600, the control unit 700 can recognize the occurrence of a user interaction.

The control unit 700 analyzes the received interaction information in step 1407. Through analysis of the interaction information, the control unit 700 identifies a particular function for controlling the external output (step 1409). When receiving the interaction information, the control unit 700 performs a given analysis process to be aware which image sensing module produces the interaction information, and then identifies a particular function mapped to the analyzed interaction information.

The control unit 700 modifies the screen data being outputted externally according to the identified particular function in step 1411, and controls the external output based on the modified screen data in step 1413. The control unit 700 sends the screen data updated by modification to the projector module 300 and controls the output of the updated screen data to the external screen 900 through the projector module 300. Related examples are discussed earlier with reference to FIGS. 4 to 13, and a detailed process of controlling the external output after the analysis of a user interaction is shown in FIG. 15.

FIG. 15 is a flow diagram illustrating a method for controlling an external output according to a user interaction based on different image sensing modules of a mobile device in accordance with an exemplary embodiment of the present invention.

Referring to FIG. 15, the control unit 700 detects a user interaction received from the image sensing module 600 in the external output mode in step 1501. Through the analysis of the user interaction, the control unit 700 determines whether the detected user interaction is based on the first image sensing module 610 or on the second image sensing module 630 in step 1503.

If the user interaction is based on the first image sensing module 610, the control unit 700 identifies currently executed content and a particular function based on the first image sensing module 610 in step 1511. When detecting a specific user interaction through the first image sensing module 610, the control unit 700 identifies a particular function mapped to the specific user interaction in the current content, as discussed earlier in FIGS. 4 to 10.

The control unit 700 controls the output of the updated screen data according to the identified particular function in step 1513. The control unit 700 modifies the screen data of the current content according to the particular function and sends the modified screen data to the projector module 300. The projector module 300 projects the updated screen data onto the external screen 900 under the control of the control unit 700.

The control unit 700 controls a predefined operation in step 1550. For example, as discussed earlier with respect to FIGS. 4 and 5, the control unit 700 may enable the first image sensing module 610 to take a photograph to acquire an image of the external screen data projected onto the external screen 900 in step 1515. The control unit 700 may produce new content based on the acquired image and store it in the memory unit 500 in step 1517. In some cases, step 1550 may be omitted according to types of the content used for the external output, as discussed earlier in FIGS. 4 to 10.

On the other hand, if the user interaction is based on the second image sensing module 630, the control unit 700 identifies currently executed content and a particular function based on the second image sensing module 630 in step 1521. For example, when detecting a specific user interaction through the second image sensing module 630, the control unit 700 finds a particular function mapped to the specific user interaction in the current content, as discussed earlier in FIGS. 11 to 13.

The control unit 700 controls the output of the updated screen data according to the identified particular function in step 1523. The control unit 700 modifies the screen data of the current content according to the particular function and then sends the modified screen data to the projector module 300. The projector module 300 projects the updated screen data onto the external screen 900 under the control of the control unit 700.

The control unit 700 controls a predefined operation in step 1525. For example, as discussed earlier in FIGS. 11 to 13, the control unit 700 may continuously control various functions according to user interactions, such as a channel shift, a volume adjustment, a pause, a rewind, a zooming, a page shift, an image slide, a screen shift, a scroll, navigation, and the like.

As fully discussed hereinbefore, according to the mobile device and related control methods provided by exemplary embodiments of the present invention, a user can control the screen data being outputted externally according to the image sensing module of the mobile device. The user can produce desired interactions for controlling the external output without any physical contact on the mobile device while concentrating his attention on the screen data being projected onto the external screen. This contact-free control for the external output may prevent undesirable shakes or variations in position of the screen data outputted externally. Additionally, the mobile device and related methods of the present invention may allow the creation of new content from a combination of the external output and the object based on any user interaction.

The above-described methods according to the present invention can be implemented in hardware or as software or computer code that can be stored in a physical recording medium, such as a CD ROM, a RAM, a floppy disk, a hard disk, or a magneto-optical disk, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A method for controlling an external output of a mobile device, the method comprising:
activating an image sensing module when entering into an external output mode;
outputting screen data externally in the external output mode;
detecting a user interaction based on the image sensing module in the external output mode; and
controlling the external output of the screen data according to the user interaction.

2. The method of claim 1, wherein the detecting of the user interaction comprises:
detecting at least one of a first interaction occurring between the mobile device and an external screen on which the screen data is displayed, and a second interaction occurring around the mobile device.

3. The method of claim 2, wherein the controlling of the external output comprises:
identifying specific content for the external output and a particular function corresponding to the first interaction;
updating the screen data according to the particular function; and
outputting externally the updated screen data.

4. The method of claim 3, further comprising:
acquiring an image of the updated screen data after outputting the updated screen data externally; and
creating and storing new content based on the acquired image.

5. The method of claim 4, wherein the new content includes a combination of the updated screen data and an object produced on the updated screen data by the user interaction.

6. The method of claim 2, wherein the controlling of the user interaction comprises:
identifying specific content for the external output and a particular function corresponding to the second interaction;
updating the screen data according to the particular function; and
outputting externally the updated screen data.

7. The method of claim 2, wherein the detecting of the first interaction comprises:
detecting at least one of a user gesture that is made within a recognizable range of the image sensing module detecting the first interaction, the formation of a distinguishably shaped or colored point by means of a pointing tool or a laser pointer on the screen data projected onto the external screen, and the formation of a particular sign by means of a marker on the screen data projected onto the external screen.

8. The method of claim 2, wherein the detecting of the second interaction comprises:
detecting a predefined user gesture that is made within a recognizable range of the image sensing module detecting the second interaction.

9. The method of claim 2, wherein the detecting of the user interaction comprises:
detecting the first interaction by a first image sensing module and the second interaction by a second image sensing module.

10. A mobile device comprising:
a projector module for outputting screen data to an external screen;
a memory unit for storing setting information related to a control of an external output function;
at least one image sensing module for detecting a user interaction in an external output mode based on the projector module; and
a control unit for receiving the user interaction from the image sensing module and, according to the received user interaction, for controlling an external output of the screen data.

11. The mobile device of claim 10, wherein the control unit updates the screen data in response to at least one of a first interaction and a second interaction and outputs the updated screen data to the external screen, the first interaction occurring between the mobile device and the external screen on which the screen data is displayed, and the second interaction occurring around the mobile device.

12. The mobile device of claim 11, wherein the image sensing module includes:
a first image sensing module for detecting the first interaction; and
a second image sensing module for detecting the second interaction.

13. The mobile device of claim 12, wherein the control unit updates the screen data according to a particular function mapped to the first interaction when receiving the first interaction, and outputs the updated screen data to the external screen.

14. The mobile device of claim 13, wherein the control unit enables the first image sensing module to acquire an image of the updated screen data after outputted externally, and creates and stores new content based on the acquired image.

15. The mobile device of claim 14, wherein the new content comprises a combination of the updated screen data and an object produced on the updated screen data by the user interaction.

16. The mobile device of claim 12, wherein the control unit updates the screen data according to a particular function mapped to the second interaction when receiving the second interaction, and controls the output of the updated screen data to the external screen.

17. The mobile device of claim 12, wherein the first image sensing module detects at least one of a user gesture that is made within a recognizable range of the image sensing module detecting the first interaction, the formation of a distinguishably shaped or colored point via a pointing tool or a laser pointer on the screen data projected onto the external screen, and the formation of a particular sign via a marker on the screen data projected onto the external screen, and produces the first interaction.

18. The mobile device of claim 12, wherein the second image sensing module detects a predefined user gesture that is made within a recognizable range of the image sensing module detecting the second interaction, and produces the second interaction.

19. The mobile device of claim 12, wherein the control unit produces the updated screen data according to the first interaction by a first image sensing module and the second interaction by a second image sensing module, and outputs the updated screen data to the external screen.

20. A method of controlling an external output of a mobile device, the method comprising:
projecting an image from the mobile device to an external object while operating in an external output mode;
detecting a user interaction while operating in the external output mode; and
controlling the projection of the image according to the detected user interaction,
wherein the user interaction is one of a first user interaction occurring between the mobile device and the external object and a second user interaction occurring around the mobile device but not necessarily between the mobile device and the external object.
